(19) United States
(12) Patent Application Publication
(10) Pub. No.: US 2005/0080668 A1
(43) Pub. Date: Apr. 14, 2005

(54) Methods and systems for programmably generating electronic creatives for display on an electronic network

(75) Inventors: Ron Hyman Rothman, New Brun Swick, NJ (US); Bret Alan Gorsline, Flemington, NJ (US)

Correspondence Address: Axiom Legal Solutions;c/o PortfolioIP, P.O. Box 52050, Minneapolis, MN, 55402, US

(73) Assignee: CNET Networks, Inc.

(21) Appl. No.: 10/681,476

(22) Filed: Oct. 8, 2003

(51) Int. Cl. G06F 17/60

(52) U.S. Cl. 705/14

(57) ABSTRACT

Methods and systems are provided for developing server-side programmable creatives and delivering those creatives over the Internet. In accord with the present invention, programmable creatives are dynamically assembled responsive to the operation of a server-side program. The program is integrated with and operated responsively to the dictates of a standard, fully-functional advertising system and has the ability to incorporate proprietary, server-side data. The invention thus takes advantage of the benefits and features of the Internet to deliver dynamically customized creatives, capable of including server-side proprietary data, in accordance with the functionality of an advertising system.

### CROSS REFERENCE TO RELATED APPLICATIONS

This invention is related to co-pending U.S. patent applications Ser. No. ______ filed on ______, by Gorsline, B. and Rothman, R. and titled METHODS AND SYSTEMS FOR PROGRAMMABLY GENERATING AGGREGATE ELECTRONIC CREATIVES FOR DISPLAY ON AN ELECTRONIC NETWORK.

### FIELD OF THE INVENTION

The present invention relates to the programmable generation of electronic creatives such as advertisements for display to users of an electronic network.

### BACKGROUND OF THE INVENTION

The World Wide Web, or Internet, has become a pervasive and fast-growing channel for many forms of electronic information distribution and exchange. It is widely used to distribute content, support different forms of communications and to enable commerce. In fact, commerce performed on the Internet has developed its own special designator—electronic commerce, or e-commerce.

Electronic advertising has grown to play a significant role in e-commerce on the Internet. Internet advertising has the ability to provide useful information directly to a potential buyer; it can facilitate the finding of goods and services. It can communicate necessary and important information to a viewer, to some extent making up for the lack of direct physical contact between viewers and products. Advertisements can serve as electronic links through the inclusion of an HTML hyperlink enabling a viewer to directly download purchase information and consummate an online transaction.

Further, electronic advertising can serve as a significant source of revenue to online publishers. Many companies are willing to pay publishers, under many different types of arrangements, for their value as an advertising channel.

Unlike traditional press, radio and television advertising, which is generally fixed in content and overly broad in distribution, electronic advertising has some ability to be adjusted and targeted to very specific buying groups. For example, in radio, television, print and direct mailing, advertising is often created or selected for a relatively broad market and then mass distributed. It is not cost-effective, for example, to create one television ad for a very narrow audience. Nor can a narrowly targeted television advertisement be effectively transmitted only to a small audience.

In contrast, many different advertisements can be cost-effectively prepared and stored for selection and distribution over the Internet. Further, based on determinable actions of an online viewer, particular advertisements can be selected and cost-effectively displayed down to the level of a single, individual viewer. Many methods are known, to those skilled in the art, of identifying online viewer interests and dynamically selecting and serving an appropriate advertisement.

It is thus seen that the Internet provides significant and fast-growing opportunities for e-commerce. Further, the Internet provides unique abilities to identify and communicate with large numbers of users, on an individual basis, substantially instantaneously and inexpensively. Not only is the Internet technically well-suited for advertising, but advertising is particularly useful to bridge the gaps associated with an electronic purchase, that is, the inability of the user to actually look at, touch and feel the merchandise being purchased.

While the evaluation of online viewer behavior is not the subject of this invention, the creation and serving of online advertising is directly pertinent. For purposes of explanation, advertising content is referred to herein as “creative(s),” the two terms being used interchangeably.

Traditional (i.e., non-programmable) creatives are typically composed of text (typically specified in HTML) and images. The text and images are displayed to viewers-responsive to a request to view a web page with advertisements—more-or-less exactly as they were entered into the ad system.

One existing type of electronic advertising incorporates what is known in the art as “client-side” programmable technology. Generally, as used herein, references to “client” refer to the individual viewers, while references to “server” refer to the online publisher. Thus, client-side technology refers to technology implemented on the viewer's local computer, while sever-side technology refers to technology implemented on the publisher's computer.

Client-side programmable technology uses software programs that are authored on the sever-side (either by the publisher or the advertiser or advertising agency), but are delivered to the client and executed on the client-side. Exemplary client-side programming platforms include Java™, JavaScript and Flash™. Each constitutes an executable program which is downloaded into a client web browser along with an HTML web page and executed on that client computer. During execution, the programs may, for example, deliver motion video and/or audio and/or special effects. Their execution can create the appearance of something ‘special’ selected for the viewer. However, client-side programs have significant limitations to their flexibility and customizability. In particular: once downloaded, communication back to the publisher's internal data sources requires impractical server security configuration. Hence, it's not practicable to dynamically include private, internal data in client-side programmable creatives. Further, client-side programmable creatives typically require special client-side web browser plug-in software and resources to execute.

Server-side programmable creatives, by comparison, require no additional client-side software or resources; perhaps more importantly, they have access to the publisher's private, internal data sources.

One existing, simple type of changeable creative is a creative template. Template-generated advertisements allow the insertion of pre-stored template-based content into an advertisement, creating some level of customization of that advertisement. However, the template language is generally simple and, once created, a template-based creative is fixed in nature, that is, it is static, not dynamically regenerated.

Another existing class of related technologies is Java Server Pages (JSPs). Like server-side programmable creatives, JSPs provides a method to dynamically customize website content. Unlike server-side programmable creatives, however, JSPs are not integrated into an advertising system, and therefore lack the associated benefits.

Despite the match of both business need and technical suitability for advertising, no solutions are known to the present inventors which take full advantage of the Internet for advertising. In particular, no solution is known to the present inventors which integrates the generation of securely-customizable creatives with the flexible, dynamic delivery capabilities of a complete advertising system.

### SUMMARY OF THE INVENTION

The present inventors have developed methods and systems for developing server-side programmable creatives and delivering those creatives over the Internet. As described below, programmable creatives are dynamically assembled responsive to the operation of a server-side program. The program is integrated with and operated responsively to the dictates of a standard, fully-functional advertising system and has the ability to incorporate proprietary, server-side data into the creatives it generates. The invention thus takes advantage of the benefits and features of the Internet to deliver dynamically customized creatives, capable of securely including server-side proprietary data, in accordance with the functionality of an advertising system.

In one embodiment of the invention there are shown and described methods and systems, the method operative in a system comprising a server-side system and a client-side system communicating through an electronic network, the method for generating a creative in an electronically transmissible format, comprising the steps of: receiving a creative definition; determining if the creative definition is a programmable or non-programmable creative definition; assembling, if the creative definition is a non-programmable creative, the non-programmable creative; and executing, if the creative definition is a programmable creative, the programmable creative definition to generate the creative.

In another embodiment there are provided methods and systems, the method operable in a system comprising a server-side system and a client-side system communicating through an electronic network, the method for generating creatives in an electronically transmissible format, comprising the steps of: storing a first definition for a non-programmable creative; storing a second definition for a programmable creative including a program for generating the programmable creative; executing the first definition to generate a non-programmable creative; storing the non-programmable creative; executing the second definition to generate a programmable creative; storing the programmable creative receiving a request to transmit a creative to a viewer; selecting, by an advertising system responsive to the request, the programmable creative or the non-programmable creative; and transmitting the selected programmable creative or non-programmable creative to the viewer.

In another embodiment of the invention, methods and systems are provided, the method for generating creatives in an electronically transmissible format, comprising the steps of: receiving a creative definition; determining if the creative definition is for a programmable or a non-programmable creative; generating, if the creative request is for a non-programmable creative, a non-programmable creative using the creative definition; generating, if the request is for a programmable creative, a programmable creative using the creative definition.

### BRIEF DESCRIPTION OF THE DRAWING FIGURES

These and other objects, features and advantages of the present invention will be apparent from a consideration of the detailed description of the invention when read in conjunction with the drawing Figures, in which:

FIG. 1 is a block diagram showing an advertisement generation system in accordance with the present invention;

FIG. 2 is a single table, depicted as cut to fit on a single page, showing exemplary contents of the advertising database of FIG. 1;

FIG. 3 is a flow chart showing an overview of a process for entering, assembling and serving programmable creatives;

FIG. 4 is a flow chart showing the programmable creatives entry process of FIG. 3;

FIG. 5 is a flow chart showing the programmable creatives assembly process of FIG. 3; and

FIG. 6 is a flow chart showing the programmable creatives serving process of FIG. 3.

### DETAILED DESCRIPTION OF THE INVENTION

There will now be shown and described details of exemplary methods and systems for providing server-side programmable creatives, that is, advertisements for electronic distribution and display over networks, the advertisements generated through the use of a definition, or program, interactive with an advertising system and internal data sources.

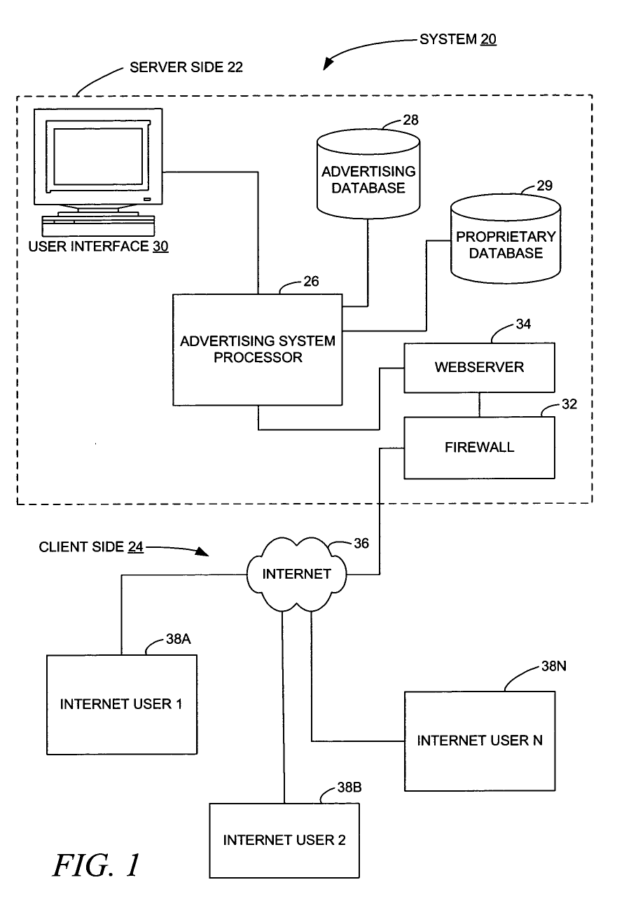

With reference now to FIG. 1 there is shown a network 20 of interconnected computer systems including a server-side system 22 and a plurality of client-side computer systems indicated generally at 24. In operation as described below, server-side system 22 is owned and operated by an e-commerce publisher desiring to transmit advertisements to client-side 24 viewers. Server-side system 22 includes an advertising system processor 26 connected to an advertising database 28, a proprietary database 29 and a user interface 30. Advertising system processor 26 is further connected through a web server 34 and a security firewall 32 to a network such as Internet 36.

Advertising system processor 26 comprises any conventional computer, for example a personal computer, server or mainframe, capable of performing the functions described below. Similarly, advertising database 28 and proprietary database 29 comprise any conventional storage system for storing the data described below as well as software for performing the processes of the present invention. Firewall 32 and web server 34 are conventional components known to those skilled in the art, the firewall providing network communications security and the web server providing an interface between client-side system 24 and server-side system 22.

Client-side systems 24 are seen to include multiple Internet users indicated at 38A, 38B, 38N. It will be appreciated that substantially any number of users may be connected to Internet 36 at any given time. It will be understood that Internet users 38A, B, N are connected to Internet 36 through conventional means, for example personal computers, personal digital assistants, cell phones or other systems enabling Internet browsing and downloading and viewing of Internet web pages.

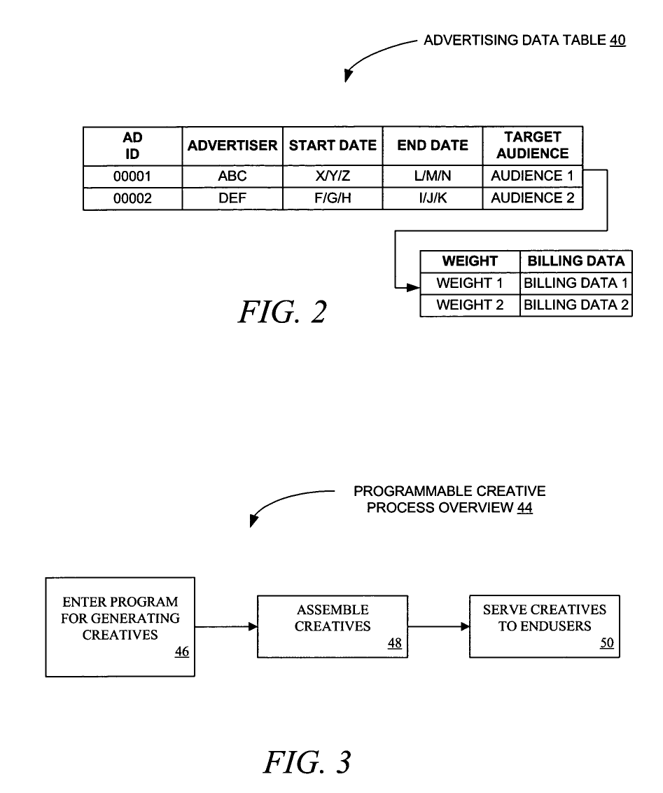

With reference now to FIG. 2, a single table 40 shows exemplary advertising data stored in advertising database 28. In the illustrated example, two entries are shown, each including a row of data fields for a specifically identified advertisement, that is advertisements 00001 and 00002. The illustrated advertising data includes the identification of the advertiser, a start date and end date for the advertisement, the target audience for the advertisement, the weight to be afforded the advertisement in relation to other advertisements served to the target audience and billing data for billing the advertiser. Numerous other data is known to the reader which may be included in table 40.

Further included in advertising database 28 for execution on advertising system processor 26 is a standard advertising software system. As is well known in the art, such an advertising system uses the advertising data in table 40 to select and serve conventional creatives. Examples of standard advertising systems include, for example, Accipiter™ Ad Manager, DoubleClick™ Ad Server, AdRevolver, et al.

Proprietary database 29 stores data proprietary to the publisher operating server-side system 22 (see FIG. 1). Such data, which may be incorporated into the server-side programmable creatives in the manner described below, includes but is not limited to, for example, survey or poll results, inventory stock counts, recent pricing data, current best-selling product information, timely information such as hours left in a sale or special event and other such data too numerous to mention.

With reference now to FIG. 3, an overview of a process for creating and delivering server-side programmable creatives 44 is shown to include the steps of entering a creative program, or definition, into advertising system processor 26 and advertising database 28 (step 46), assembling by the processor, using the creative program, advertising data and proprietary data in database 29, the programmable creative (step 48) and serving the generated creative (step 50) out of the server-side system 22 through firewall 32 and web server 34 to a client-side Internet user/viewer. From a consideration of the following it will be understood that a key feature of the present invention is the use of a program, for example a Perl program, to define the creatives. This is in contrast to conventional creatives defined by standard HTML text. As described below, the program is integrated with the standard advertising system operated by server-side system 22 and has access, during the assembly of the creatives on the server-side, to proprietary data in database 29.

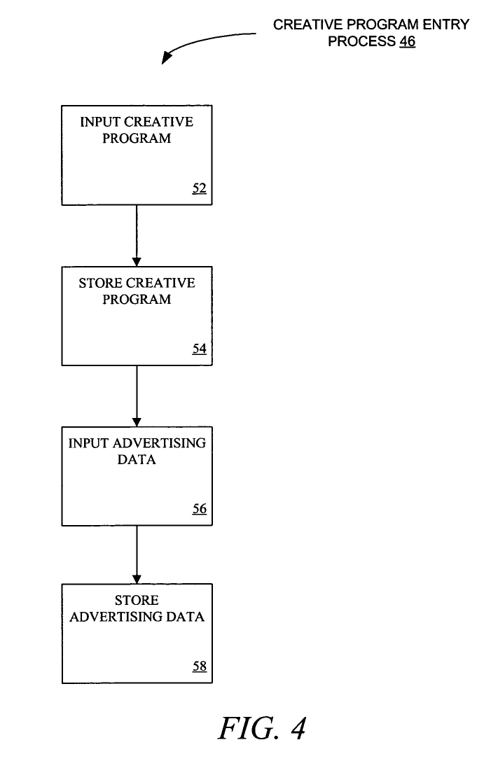

Referring now to FIG. 4, the process 46 for entering creative programs and data is seen to include the steps of inputting (step 52) and storing (step 54) a creative program. Subsequently the advertising data, described above with respect to table 40 (FIG. 3) is input (step 56) and stored (step 58). It will be understood that conventional, non-programmable creative definitions are input into and stored in advertising database 28 in accordance with conventional practice. Such non-programmable creative definitions typically include text and images and are used to construct the known, conventional advertisements described in the background of the invention above.

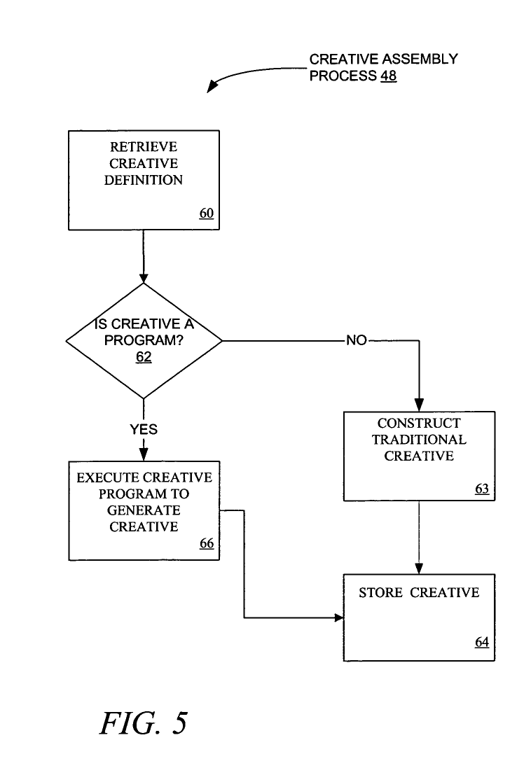

With reference now to FIG. 5, the details of the creative assembly process 48 are shown wherein a creative definition is retrieved (step 60) from advertising database 28. As described above, advertising database 28 stores the programs for programmable creatives, definitions for standard, non-programmable creatives, advertising data and advertising system software. Proprietary data is stored in proprietary database 29.

Continuing with reference to FIG. 5, the creative definition is analyzed (step 62) by advertising system processor 26 to determine if it is a creative to be formed by a program, that is a programmable creative in accordance with the present invention, or a traditional, non-programmable creative. If the creative definition is not a program, then the traditional non-programmable creative is constructed (step 63) and stored in advertising database 28 for serving (step 64). It will be understood that a traditional, non-programmable creative consists typically of text and images in a web-browser compatible format, such as HTML.

It will be understood that creative assembly process 48 is executed by the advertising system software operated by advertising system processor 28.

If the creative definition is a program, then that program is executed (step 66) to generate the creative defined by the program and the generated creative is stored (step 64) for serving.

It will be understood that programs for defining programmable creatives can take many different forms and provide many different results. They may be written in Java, in Perl as noted above, or in any software language capable of producing web-browser-readable text.

More specifically, an interpreter executed by the advertising system software executes, in turn, each active programmable creative in advertising system database 28. There is a well-defined interface between the interpreter and the creative programs; the entry points and return mechanisms are all defined by an Application Programming Interface (API), which is available to the creative program author.

Before executing the program, the interpreter creates a context in which the programmable creative will run. The context contains data which the program may access during its execution (via the API), including the relevant advertising data 40.

The API provided by the interpreter to the programmer provides functions that enable the program to, amongst other well-known functions:
register an entry point (function) which the interpreter will use (call) to generate the program's output
retrieve information about the programmable creative itself, e.g.,
   the advertiser's name,
   scheduling information (such as weight, expiration date, etc.)
register with the interpreter the creative text to be presented to a viewer
log an error
abort the program

In addition to this API, the program may make use of any additional libraries that are available to it. For example, to connect to an external database, the program might import a particular vendor's database driver library.

A program has several options upon encountering an error condition. It can inform the interpreter that it is to be aborted completely, or it can choose to generate a “default” creative text which can be displayed to the end-user. The program may also log (via an interpreter API call) any messages it deems helpful.

Each creative program is executed periodically by the advertising program in accordance with its definition, the frequency of execution determined by the programmer based on how frequently it is desired to update the content of the generated creatives. For example, one programmable creative may be executed every few minutes to show changes in inventory, whereas another may be executed daily to show changes in a slower-changing variable such as pricing. Each time the creative program is executed, it may generate different creative text for display to viewers. This periodic regeneration allows the creative to be dynamic, that is, to change over time, for example in response to updated proprietary and/or publicly available data. The creative program is a candidate for execution only while it is active in accordance with the start and end dates in advertising data 40.

Note that once a creative program is executed, the resulting creative text is treated by the advertising system as identical to a traditional, non-programmable creative that was directly entered.

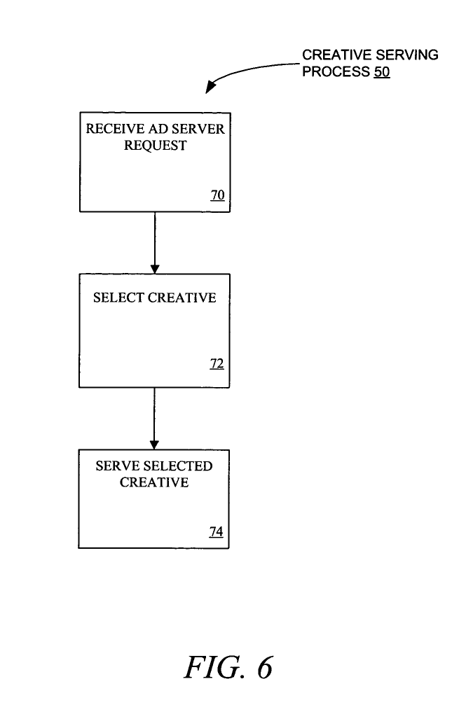

With reference now to FIG. 6, the creative serving process 50 is seen to include receiving a request from web server 34, responsive to a request to deliver an advertisement (step 70) to an Internet user 38. Under the control of the advertising system software running on advertising system processor 26 and based on advertising data stored in table 40 of advertising database 28, including the dates, targeted audience, weight and other relevant data, a creative is selected (step 72) from advertising database 28 and served to the Internet user (step 74) through firewall 32 and web server 34. As noted above, the selected creative may be a programmable creative in accordance with the present invention or a traditional, non-programmable creative, as selected by the advertising system.

It will thus been seen that the invention provides the advantage of an unprecedented level of dynamicism; that is, programmable creatives can easily be authored so that they automatically change over time. With the present invention, it is possible for creatives to be automatically generated and regenerated, as frequently as is desired, without any additional user interaction.

A further significant advantage is the ability for programmable creatives to access private, internal databases, such as private database 29, and to include information derived from those databases in the generated creative text.

An example illustrating the operation of the present invention, and particularly the ability to incorporate server-side data into complex programmable creatives, comprises using a programmable creative to display links to currently “hot” products. Such a program might:
1. connect to a private, internal product database,
2. select up to 5 “most-popular” products which are on sale at that time and whose manufacturers currently have ads running in the advertising system,
3. remove any competing manufacturers from the list,
4. generate creative text which has two sections, separated by a horizontal rule:
   a. a top section, which has an appropriately-sized advertisement for each of the manufacturers in the list, and
   b. a bottom section, which has links to buy each of the products in the list of preferred vendors,
5. if either section or both sections are empty due, for example, to the particular combination of most-popular products and current advertisers, then generate a creative form which simply has up to 5 links to most-popular products.
   a. if there are no “most-popular” products, then generate no creative text and notify the ad administrator.

Additional examples of programmable creatives enabled by the present invention include, but are not limited to:
A creative which ties into survey or poll results. For example, the creative could display current product approval results, and present a link which the user could use to vote on the product, as well as a link with which the user could buy the product.
A creative which contains text stating inventory information, for example, “There are only 45 XYZ notebooks left in stock. Click here to get yours-before it's too late!” Using the present invention, the number left in stock can be updated every 15 minutes; when there are no more items left, the programmed creative can in cooperation with the advertising system remove itself from the rotation of active creatives.
A creative which states, “Only 9 hours remain in the 2003 MEGA-BIG notebook sale of the century! Click here to get a super-duper deal!” In accordance with the present invention, the number of hours remaining can be updated hourly.

As described above, the program used to assemble a programmable creative can retrieve information stored on the server-side 22, for example in advertising database 28 and/or proprietary database 29. As noted above, the program can also be operated to retrieve and use server-side data from other databases connected to advertising system processor 26, for example and without limitation: stock price data, third-party pricing and inventory data, and almost limitless other data which will now be apparent to the reader.

There have thus been provided methods and systems for generating programmable creatives, that is creatives that are assembled in accordance with infinitely flexible and dynamic programs able to draw in an infinite range of proprietary and non-proprietary data. These programmable creatives can be integrated to operate with conventional advertising system software programs and thus be used interchangeably with conventional, non-programmable creatives. The invention has application in the creation of electronically-based advertisements, typically for distribution over electronic networks such as the Internet.

While the invention has been illustrated and described with respect to particular embodiments, it is not thus limited. Numerous modifications, changes and improvements within the scope of the invention will occur to the reader.

1. In a system comprising a server-side system and a client-side system communicating through an electronic network, a method for generating a creative in an electronically transmissible format, comprising the steps of:
receiving a creative definition;
determining if the creative definition is a programmable or non-programmable creative definition;
assembling, if the creative definition is a non-programmable creative, the non-programmable creative; and
executing, if the creative definition is a programmable creative, the programmable creative definition to generate the creative.

2. The method of claim 1 wherein the step of executing the programmable creative definition to generate the creative includes the step of periodically executing the programmable creative definition responsive to a request generated by an advertising system.

3. The method of claim 1 wherein the step of executing the programmable creative definition to generate the creative includes the step of retrieving, responsive to the programmable creative definition, data from the server-side system.

4. The method of claim 3 wherein the data is proprietary data.

5. The method of claim 1 and further including the step of transmitting the creative to a web server for transmission to an end-user.

6. The method of claim 1 wherein the step of executing, if the creative definition is a programmable creative, the programmable creative definition to generate the creative includes the step of periodically changing text within the creative.

7. The method of claim 1 wherein the step of executing, if the creative definition is a programmable creative, the programmable creative definition to generate the creative includes the step of periodically changing an image within the creative.

8. The method of claim 1 wherein the step of executing, if the creative definition is a programmable creative, the programmable creative definition to generate the creative includes the step of periodically changing a hyperlink within the creative.

9. In a system comprising a server-side system and a client-side system communicating through an electronic network, a system for generating a creative in an electronically transmissible format, comprising:
a processor;
a memory connected to the processor, the memory storing data and instructions for controlling the operation of the processor;
the processor operative with the data and control instructions in the memory to perform the steps of
receiving a creative definition;
determining if the creative definition is a programmable or non-programmable creative definition;
assembling, if the creative definition is a non-programmable creative, the non-programmable creative; and
executing, if the creative definition is a programmable creative, the programmable creative definition to generate the creative.

10. The system of claim 9 wherein the step of executing the programmable creative definition to generate the creative includes the step of periodically executing the programmable creative definition responsive to a request generated by an advertising system.

11. The system of claim 9 wherein the step of executing the programmable creative definition to generate the creative includes the step of retrieving, responsive to the programmable creative definition, data from the server-side system.

12. The system of claim 11 wherein the data is proprietary data.

13. The system of claim 9 and further including the step of transmitting the creative to a web server for transmission to an end-user.

14. The system of claim 9 wherein the step of executing, if the creative definition is a programmable creative, the programmable creative definition to generate the creative includes the step of periodically changing text within the creative.

15. The system of claim 9 wherein the step of executing, if the creative definition is a programmable creative, the programmable creative definition to generate the creative includes the step of periodically changing an image within the creative.

16. The system of claim 9 wherein the step of executing, if the creative definition is a programmable creative, the programmable creative definition to generate the creative includes the step of periodically changing a hyperlink within the creative.

17. In a system comprising a server-side system and a client-side system communicating through an electronic network, a system for generating a creative in an electronically transmissible format, comprising:
means for receiving a creative definition;
means for determining if the creative definition is a programmable or non-programmable creative definition;
means for assembling, if the creative definition is a non-programmable creative, the non-programmable creative; and
means for executing, if the creative definition is a programmable creative, the programmable creative definition to generate the creative.

18. A program product storing instructions operable on a computer, the instructions operable in a system comprising a server-side system and a client-side system communicating through an electronic network for generating a creative in an electronically transmissible format, the program product storing instructions operable on the computer to perform the steps of:
receiving a creative definition;
determining if the creative definition is a programmable or non-programmable creative definition;
assembling, if the creative definition is a non-programmable creative, the non-programmable creative; and
executing, if the creative definition is a programmable creative, the programmable creative definition to generate the creative.

19. In a system comprising a server-side system and a client-side system communicating through an electronic network, a method for generating creatives in an electronically transmissible format, comprising the steps of:
storing a first definition for a non-programmable creative;
storing a second definition for a programmable creative including a program for generating the programmable creative;
executing the first definition to generate a non-programmable creative;
storing the non-programmable creative;
executing the second definition to generate a programmable creative;
storing the programmable creative receiving a request to transmit a creative to a viewer;
selecting, by an advertising system responsive to the request, the programmable creative or the non-programmable creative; and
transmitting the selected programmable creative or non-programmable creative to the viewer.

20. The method of claim 19 wherein the step of executing the second definition to generate a programmable creative includes the step of periodically executing the second definition to generate an updated programmable creative.

21. The method of claim 19 wherein the step of executing the second definition to generate a programmable creative includes the step of retrieving, responsive to the program, data from the server-side system for inclusion in the programmable creative.

22. The method of claim 19 and further including the step of transmitting the selected programmable creative or non-programmable creative to a web server for transmission to the viewer.

23. The method of claim 19 wherein the step of executing the second definition to generate a programmable creative includes the step of periodically changing text within the programmable creative.

24. The method of claim 19 wherein the step of executing the second definition to generate a programmable creative includes the step of periodically changing an image within the programmable creative.

25. The method of claim 19 wherein the step of executing the second definition to generate a programmable creative includes the step of periodically changing a hyperlink within the programmable creative.

26. In a system comprising a server-side system and a client-side system communicating through an electronic network, a system for generating creatives in an electronically transmissible format, comprising:
a processor;
a memory connected to the processor, the memory storing data and instructions for controlling the operation of the processor;
the processor operative with the data and control instructions in the memory to perform the steps of
storing a first definition for a non-programmable creative;
storing a second definition for a programmable creative including a program for generating the programmable creative;
executing the first definition to generate a non-programmable creative;
storing the non-programmable creative;
executing the second definition to generate a programmable creative;
storing the programmable creative
receiving a request to transmit a creative to a viewer;
selecting, by an advertising system responsive to the request, the programmable creative or the non-programmable creative; and
transmitting the selected programmable creative or non-programmable creative to the viewer.

27. The system of claim 26 wherein the step of executing the second definition to generate a programmable creative includes the step of periodically executing the second definition to generate an updated programmable creative.

28. The system of claim 26 wherein the step of executing the second definition to generate a programmable creative includes the step of retrieving, responsive to the program, data from the server-side system for inclusion in the programmable creative.

29. The system of claim 26 and further including the step of transmitting the selected programmable creative or non-programmable creative to a web server for transmission to the viewer.

30. The system of claim 26 wherein the step of executing the second definition to generate a programmable creative includes the step of periodically changing text within the programmable creative.

31. The system of claim 26 wherein the step of executing the second definition to generate a programmable creative includes the step of periodically changing an image within the programmable creative.

32. The system of claim 26 wherein the step of executing the second definition to generate a programmable creative includes the step of periodically changing a hyperlink within the programmable creative.

33. In a system comprising a server-side system and a client-side system communicating through an electronic network, a system for generating creatives in an electronically transmissible format, comprising:
means for storing a first definition for a non-programmable creative;
means for storing a second definition for a programmable creative including a program for generating the programmable creative;
means for executing the first definition to generate a non-programmable creative;
means for storing the non-programmable creative;
means for executing the second definition to generate a programmable creative;
means for storing the programmable creative means for receiving a request to transmit a creative to a viewer;
means for selecting, by an advertising system responsive to the request, the programmable creative or the non-programmable creative; and
means for transmitting the selected programmable creative or non-programmable creative to the viewer.

34. A program product storing instructions operable on a computer, the instructions operable in a system comprising a server-side system and a client-side system communicating through an electronic network for generating a creative in an electronically transmissible format, the program product storing instructions operable on the computer to perform the steps of:
storing a first definition for a non-programmable creative;
storing a second definition for a programmable creative including a program for generating the programmable creative;
executing the first definition to generate a non-programmable creative;
storing the non-programmable creative;
executing the second definition to generate a programmable creative;
storing the programmable creative receiving a request to transmit a creative to a viewer;
selecting, by an advertising system responsive to the request, the programmable creative or the non-programmable creative; and
transmitting the selected programmable creative or non-programmable creative to the viewer.

35. A method for generating creatives in an electronically transmissible format, comprising the steps of:
receiving a creative definition;
determining if the creative definition is for a programmable or a non-programmable creative;
generating, if the creative request is for a non-programmable creative, a non-programmable creative using the creative definition; and
generating, if the request is for a programmable creative, a programmable creative using the creative definition.

36. The method of claim 35 wherein the step of generating, if the request is for a programmable creative, a programmable creative using the creative definition includes the step of periodically executing the programmable creative definition responsive to a request generated by an advertising system.

37. The method of claim 35 wherein the step of generating, if the request is for a programmable creative, a programmable creative using the creative definition includes the step of retrieving, responsive to the programmable creative definition, data from the server-side system.

38. The method of claim 37 wherein the data is proprietary data.

39. The method of claim 35 and further including the step of transmitting the creative to a web server for transmission to an end-user.

40. The method of claim 35 wherein the step of generating, if the request is for a programmable creative, a programmable creative using the creative definition includes the step of periodically changing text within the creative.

41. The method of claim 35 wherein the step of generating, if the request is for a programmable creative, a programmable creative using the creative definition includes the step of periodically changing an image within the creative.

42. The method of claim 35 wherein the step of generating, if the request is for a programmable creative, a programmable creative using the creative definition includes the step of periodically changing a hyperlink within the creative.

43. A system for generating creatives in an electronically transmissible format, comprising:
a processor;
a memory connected to the processor, the memory storing data and instructions for controlling the operation of the processor;
the processor operative with the data and control instructions in the memory to perform the steps of
receiving a creative definition;
determining if the creative definition is for a programmable or a non-programmable creative;
generating, if the creative request is for a non-programmable creative, a non-programmable creative using the creative definition; and
generating, if the request is for a programmable creative, a programmable creative using the creative definition.

44. The system of claim 43 wherein the step of generating, if the request is for a programmable creative, a programmable creative using the creative definition includes the step of periodically executing the programmable creative definition responsive to a request generated by an advertising system.

45. The system of claim 43 wherein the step of generating, if the request is for a programmable creative, a programmable creative using the creative definition includes the step of retrieving, responsive to the programmable creative definition, data from the server-side system.

46. The system of claim 45 wherein the data is proprietary data.

47. The system of claim 43 and further including the step of transmitting the creative to a web server for transmission to an end-user.

48. The system of claim 43 wherein the step of generating, if the request is for a programmable creative, a programmable creative using the creative definition includes the step of periodically changing text within the creative.

49. The system of claim 43 wherein the step of generating, if the request is for a programmable creative, a programmable creative using the creative definition includes the step of periodically changing an image within the creative.

50. The system of claim 43 wherein the step of generating, if the request is for a programmable creative, a programmable creative using the creative definition includes the step of periodically changing a hyperlink within the creative.

51. A system for generating creatives in an electronically transmissible format, comprising:
means for receiving a creative definition;
means for determining if the creative definition is for a programmable or a non-programmable creative;
means for generating, if the creative request is for a non-programmable creative, a non-programmable creative using the creative definition; and
means for generating, if the request is for a programmable creative, a programmable creative using the creative definition.

52. A program product storing instructions operable on a computer, the instructions operable in a computer for generating creatives in an electronically transmissible format, the program product storing instructions operable on the computer to perform the steps of:
receiving a creative definition;
determining if the creative definition is for a programmable or a non-programmable creative;
generating, if the creative request is for a non-programmable creative, a non-programmable creative using the creative definition; and
generating, if the request is for a programmable creative, a programmable creative using the creative definition.
